(19) United States
(12) Patent Application Publication
(10) Pub. No.: US 2025/0126135 A1
(43) Pub. Date: Apr. 17, 2025

(54) METHOD FOR DETERMINING THREAT SCENARIO

(71) Applicant: ASTRON SECURITY INC., Seoul (KR)

(72) Inventors: Keun Seok CHO, Anyang-si (KR); Dong Ik KWAK, Hwaseong-si (KR)

(73) Assignee: ASTRON SECURITY INC., Seoul (KR)

(21) Appl. No.: 18/528,892

(22) Filed: Dec. 5, 2023

(30) Foreign Application Priority Data
Oct. 12, 2023 (KR) 10-2023-0136288

(51) Int. Cl. H04L 9/40

(52) U.S. Cl. CPC H04L 63/1416; H04L 63/1441

(57) ABSTRACT

A method for determining a threat scenario includes the steps of selecting target API events from a user's API event data in a cloud environment based on criteria like frequency, timing, location, user, and type, mapping these to classified threat behaviors, forming a threat behavior set, identifying candidate scenarios from a database, generating security indicators by comparing candidates with the threat behavior set, determining the most likely threat scenario based on these indicators, and providing solutions to a user terminal based on this scenario.

### CROSS-REFERENCE TO RELATED APPLICATIONS

This application claims priority to and the benefit of Korean Patent Application No. 10-2023-0136288, filed on Oct. 12, 2023, which is incorporated herein by reference in its entirety.

### FIELD

The present disclosure relates to a method for determining a threat scenario using generative AI, and more particularly, to a method for generating multiple suspected threat scenarios based on AI's pattern recognition and learning capabilities, evaluating the generated threat scenarios with precision, and offering solutions generated based on a result of the evaluation, so that a user is provided with preemptive solutions before a cyber-attack.

### BACKGROUND

The statements in this section merely provide background information related to the present disclosure and may not constitute prior art.

Generally, defending against and responding to cyber-attacks are implemented through network devices and application-level solutions. System logs are maintained for audit purposes or for incident analysis and response when a breach occurs.

For defense against cyber-attacks by network devices, network devices such as routers and switches, general network security devices such as Intrusion Detection Systems (IDS) and firewalls, and application-level network security devices such as Web Application Firewalls (WAF) and application-level DDOS protection equipment are used.

For defense against cyber-attacks by application-level solutions, Digital Rights Management (DRM), antivirus (AV), and the like are used.

Recently, cyber-attacks have increased in frequency, and their methods have become more sophisticated. Examples of such cyber-attacks include Advanced Persistent Threats (APTs), which involve sustained attacks on a specific organization over an extended period to achieve an attack goal such as data exfiltration, and Denial of Service (DOS) or Distributed Denial of Service (DDOS) attacks.

In response, measures to defend against and respond to cyber-attacks have evolved to analyze information collected from various security solutions and system logs.

Examples of the measures may include Enterprise Security Management (ESM) and Security Information and Event System (SIEM).

Furthermore, technologies are being developed to integrate and manage various logs, similar to ESM or SIEM. This enables functionalities such as log searching, querying, system status assessment, as well as detection of and response to various cyber-attacks.

However, the defensive measures against cyber-attacks have limitations in effectively defending and responding to such attacks, primarily due to the challenges in accurately perceiving the current situation in cyberspace.

Contemporary cyber-attacks, particularly, are not isolated incidents; instead, attackers tend to employ various attack methods sequentially over an extended period to achieve their attack goals. Therefore, accurately recognizing the current situation in cyberspace and preemptively responding to cyber-attacks are crucial for effective defense and response.

Therefore, there is an emphasized need to effectively defend against scenario-based cyber-attacks through scenario-based multi-stage attack analysis and to provide solutions for preemptive responses to these attacks. Document Korean Patent Application Publication No. 10-2015-0008158 relates to systems and methods for identifying, deterring and/or delaying attacks to a network using shadow networking technique.

The above information discloses in this Background section is only for enhancement of understanding of the background of the present disclosure, and therefore it may contain information that does not form the prior art that is already known to a person of ordinary skill in the art.

### SUMMARY

An object of the present disclosure is to determine solutions for attacker risk scenarios based on a generative AI and provide the solutions to a user.

In one aspect of the present disclosure, there is provided a method for determining a threat scenario, the method including: determining a plurality of target API events based on predetermined criteria among a user's API event information obtained in a cloud environment, wherein the predetermined criteria is associated with at least one of occurrence frequency, temporal distribution, occurrence location, associated user, and type of an API event; mapping the plurality of target API events respectively to a plurality of threat behaviors classified by type; determining at least one threat behavior set including at least one threat behavior among the plurality of threat behaviors; based on the threat behavior set, determining at least one candidate scenario among a plurality of reference scenarios pre-stored in a database; producing security indicator information by comparing the at least one candidate scenario with the threat behavior set; determining an expected threat scenario among the at least one candidate scenario based on the security indicator information; and providing a user terminal with solution information based on the expected threat scenario.

In one embodiment of the present disclosure, sub-classification types of the threat behaviors may include tactics, techniques, and detailed techniques. Each of the tactics may be a higher-level concept comprising at least one of the techniques and each of the techniques may be a higher-level concept comprising at least one of the detailed techniques.

In one embodiment of the present disclosure, the security indicator information may include consistency information and risk information.

In one embodiment of the present disclosure, the consistency information may be produced based on type relevance to threat behaviors included in the at least one candidate scenario.

In one embodiment of the present disclosure, sub-classification types of the threat behaviors may include tactics, techniques, and detailed techniques. Each of the tactics may be a higher-level concept comprising at least one of the techniques and each of the techniques may be a higher-level concept comprising at least one of the detailed techniques. An indicator corresponding to the type relevance may be produced differentially based on consistency between the tactics, the techniques, and the detailed techniques for the threat behaviors included in the at least one candidate scenario.

In one embodiment of the present disclosure, the security indicator information may include risk information, each of the plurality of reference scenarios pre-stored in the database may include a risk indicator corresponding thereto, and the risk information may be produced based on progress information that is generated by comparing the risk indicator and a threat behavior included in the threat behavior set and the at least one candidate scenario.

In one embodiment of the present disclosure, the plurality of reference scenarios pre-stored in the database may be scenarios each composed of at least some threat behaviors selected from a plurality of techniques included in a threat behavior analysis matrix. The threat behavior analysis matrix may be composed of a plurality of tactics and at least one technique included in each of the plurality of tactics.

In one embodiment of the present disclosure, in the determining of the at least one candidate scenario, the at least one candidate scenarios may be determined further based on cyber-attack stage types.

The cyber-attack stage types may include a pre-attack stage, an attack stage, and a post-attack stage based on Cyber Kill Chain model, and a sequence of the stages is determined by temporal occurrence order or causality, and the threat behavior may correspond to at least one of the cyber-attack stage types.

In one embodiment of the present disclosure, the solution information may be determined based on a cyber-attack stage type corresponding to a last threat behavior occurring in the expected threat scenario.

In one embodiment of the present disclosure, when the cyber-attack stage type corresponds to the pre-attack stage, the user may be provided with a warning and defensive measures against an initial infiltration attempt; when the cyber-attack stage type corresponds to the attack stage, the user may be provided with detailed information regarding an attack currently in progress and countermeasures therefor; and when the cyber-attack stage type corresponds to the post-attack stage, the user may be provided with potential threats, preventive measures, and a recovery plan after the attack.

In one embodiment of the present disclosure, at least one of the predetermined criteria may be determined based on the cyber-attack stage type.

In one embodiment of the present disclosure, the determining of the threat behavior set may further include classifying the threat behavior based on a classification criterion associated with to at least one of occurrence frequency, temporal distribution, occurrence location, and associated user of the threat behavior, and the threat behavior set may be composed of threat behaviors determined based on the classification criterion.

In one embodiment of the present disclosure, the method may further include: acquiring weight information corresponding to a classification criterion from the user terminal; and changing threshold information for determining a range of the classification criterion, based on the weight information.

In one embodiment of the present disclosure, the threat behavior set may be determined based on an AI-based classification algorithm, and the classification algorithm may include at least one of machine learning, deep learning, or reinforcement learning.

In one embodiment of the present disclosure, the database may store relationship information regarding time intervals and causal relationships between threat behaviors included in each of the plurality of reference scenarios, in the determining of the threat behavior set, the threat behavior set may be determined based on the relationship information.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a diagram illustrating an example of a network environment according to an embodiment of the present disclosure;

FIG. 2 is a flowchart illustrating a method for determining a threat scenario according to an embodiment of the present disclosure;

FIGS. 3 and 4 are tables for explaining threat behaviors classified by type according to an embodiment of the present disclosure;

FIG. 5 is a diagram illustrating an example of a threat behavior analysis matrix according to an embodiment of the present disclosure;

FIG. 6 is a table explaining a plurality of pre-stored reference scenarios according to an embodiment of the present disclosure;

FIGS. 7 and 8 are diagrams illustrating a method for determining a threat scenario according to an embodiment of the present disclosure; and

FIG. 9 is a flowchart illustrating a method for determining a threat scenario according to another embodiment of the present disclosure.

The drawings described herein are for illustration purposes only and are not intended to limit the scope of the present disclosure in any way.

### DETAILED DESCRIPTION

Hereinafter, the present disclosure will be described in detail according to exemplary embodiments disclosed herein, with reference to the accompanying drawings. For the sake of brief description with reference to the drawings, the same or equivalent components may be provided with the same or similar reference numbers, and description thereof will not be repeated. In addition, in the following description of the embodiments, a detailed description of known functions and configurations incorporated herein will be omitted when it may impede the understanding of the embodiments.

While terms including ordinal numbers, such as “first” and “second,” etc., may be used to describe various components, such components are not limited by the above terms. The above terms are used only to distinguish one component from another.

The singular forms are intended to include the plural forms as well, unless the context clearly indicates otherwise.

Steps described in this application may be performed regardless of the listed order, except when they must be performed in the listed order due to a special causal relationship.

It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, the present disclosure will be described with reference to the attached drawings.

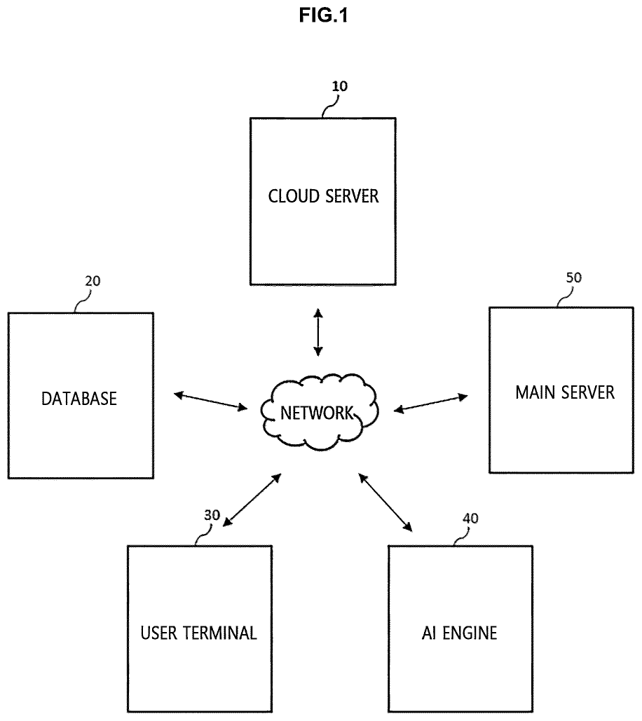

FIG. 1 is a diagram illustrating an example of a network environment according to an embodiment of the present disclosure.

The network environment according to an embodiment of the present disclosure shown in FIG. 1 may include a cloud server 10, a database 20, a user terminal 30, an AI engine 40, and a main server 50.

In this case, the cloud server 10, the database 20, the user terminal 30, the AI engine 40, and the main server 50 may be connected to each other based on communication, that is, a network. Here, communication schemes for the network is not limited. The communication schemes may include not only a communication scheme to utilize a telecommunication network (for example, a mobile communication network, wired Internet, wireless Internet, and a broadcast network), but also a short-range radio communication scheme.

The cloud server 10 refers to a server for cloud services, which involves outsourcing servers and storage devices externally rather than having them within the enterprise. In this context, the cloud server 10 may include a public data center (e.g., Amazon AWS and Microsoft Azure) for public cloud services and on-premises data centers for private cloud services.

Such a cloud server 10 may be implemented as a computer device or a plurality of computer devices that provide commands, codes, files, content, services, etc. The cloud server 10 may communicate with other servers and terminals included in a system through a network to exchange information.

In such a cloud server 10, all data and infrastructure of users using the server may be stored. In this case, a specific user or user groups may use only one cloud server 10 or a plurality of cloud servers 10.

Preferably, when the plurality of cloud servers 10 is used, a separate integrated control server for managing data distributed across the plurality of cloud servers 10 may be provided. More preferably, the main server 50 to be described later may perform the role of the integrated control server.

The user terminal 30 is an entity that accesses a specific company or organization's data stored in the cloud server 10 to read and write data. In this case, the user terminal 30 authorized to access the cloud server 10 may be a member of a company, organization, or group. If an unauthorized user attempts to access the cloud server 10 of the company, organization, or group, this access may be regarded as a cyber threat or attack, which is commonly known as hacking.

This user terminal 30 may be implemented as a computer device or a plurality of computer devices providing commands, codes, files, contents, services, and the like.

The cloud server 10 may communicate with other servers and terminals included in a system through a network to exchange information.

The database 20 may serve as a storage medium for storing data. Preferably, in the present disclosure, the database 20 may store a plurality of reference scenarios, which are cyber threats, that is, hacking scenarios.

This database 20 may be implemented as a computer device or a plurality of computer devices that provide commands, codes, files, content, services, etc. In addition, the database 20 may communicate with other servers and terminals included in a system through a network to exchange information.

Furthermore, the database 20 may store information on actions (defensive measures) that defenders (administrators) can take to prevent and detect cyber-attacks, and may also store analyzed data on named hacking groups and their attack techniques.

Here, a reference scenario refers to a process in which an attacker performs step-by-step actions to carry out a cyber-attack. In such a scenario, actions performed by the attacker at each step are listed time-sequentially.

Therefore, the database 20 may basically store reference scenarios for past hacking incidents, or threatening attacks. Preferably, each reference scenario may be a sequence of various Tactics, Techniques, and Procedures (TTPs) included in a threat behavior analysis matrix stored in the MITRE ATT&CK (Adversarial Tactics, Techniques, and Common Knowledge) based on attack patterns used by actual cyber attackers.

Here, the MITRE ATT&CK is a cyber security-related knowledge base created by MITRE Corporation and may be composed of tactics with categories for cyber attackers' objectives and steps, and techniques which are specific methods for the tactics.

Accordingly, a threat behavior is included in at least one tactic, and corresponds to at least one technique included in the tactic.

In addition, reference scenarios pre-stored in the database 20 are data that is classified and listed information on various attack groups' techniques, which are analyzed in terms of tactics and techniques, regarding adversary behaviors employed by attackers in cyber-attacks.

Specifically, a threat scenario includes at least one technique, which is a single step in a method for an attacker to achieve at least one tactic, which is an attack goal.

For example, a threat behavior type corresponding to the technique may include Spearphishing via Email, Drive-by Compromise, Credential Dumping, Man-in-the-Middle attack (MitM), Command and Control over alternative protocol, etc.

The AI engine 40 refers to a conventional artificial intelligence (AI) engine and may represent various AI engines 40 provided conventionally. Preferably, in the present disclosure, the term “AI engine” refers to generative AI, and the term “artificial intelligence” is understood to have the same meaning as the AI engine 40.

The AI engine 40 may be implemented as a computer device or a plurality of computer devices providing commands, codes, files, contents, services, and the like. In addition, the AI engine 40 may communicate with other servers and terminals included in the system through a network to exchange information.

The main server 50 performs the integrated control function for the plurality of cloud servers 10 and also detects and analyzes cyber threats to provide various prompts to an authorized user terminal 30, that is, a user terminal of a defender (administrator).

The main server 50 may be implemented as a computer device or a plurality of computer devices providing commands, codes, files, contents, services, and the like. The main server 50 may communicate with other servers and terminals in the system through a network to exchange information.

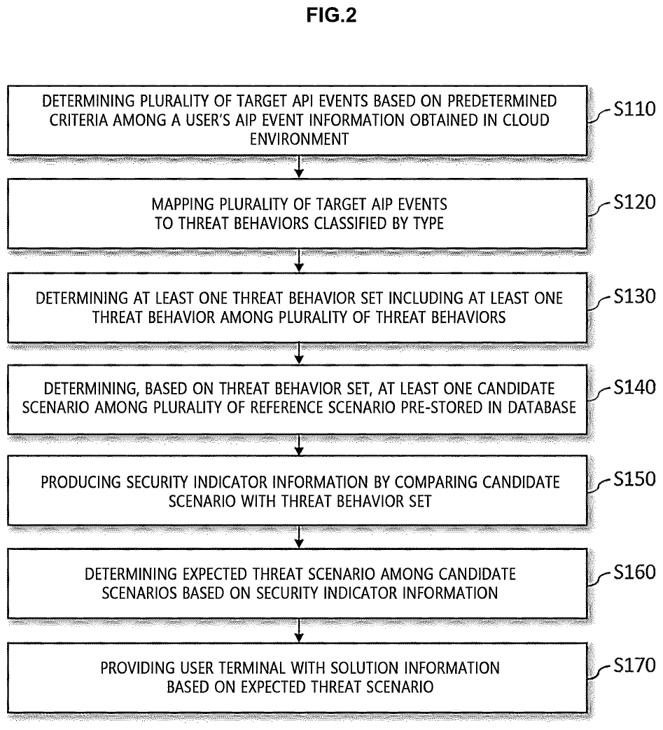

FIG. 2 is a flowchart illustrating a method for determining a threat scenario according to an embodiment of the present disclosure.

In operation S110, a main server 50 determines a plurality of target API events based on predetermined criteria among a user's API event information obtained in a cloud environment.

Here, the API event information may be an API interaction such as the user's API call or response thereto. For example, the API event information may include an endpoint (URL) used in the API call, an HTTP method, request and response payloads, and an event occurrence time.

The main server 50 determines a plurality of target API events based on predetermined criteria among the API event information obtained by the cloud server 10.

Here, the predetermined criteria may be associated with at least one of occurrence frequency, temporal distribution, occurrence location, associated user, and type of an API event.

For example, in the case of determining a plurality of target API events determined based on event frequency, the occurrence frequency of each API event may be calculated to estimate the quantity of a corresponding event occurring over a specific period and a period where the occurrence frequency exceeds a predetermined threshold may be set as a criterion.

For example, in the case of determining a plurality of target API events determined based on temporal distribution, the occurrence time of each API event may be tracked to identify patterns and a specific time period with concentrated occurrences may be set as a criterion.

For example, in the case of determining a plurality of target API events based on occurrence location and associated user, an event occurring in a user's account associated with an API event in question, occurring in a specific region may be set as a criterion.

For example, in the case of determining a plurality of target API events based on an API event type, a specific event type may be set as a criterion by identifying the types of events such as login requests, data modifications, data deletions, and so forth.

In operation S120, the main server 50 maps the plurality of target API events to threat behaviors classified by type. Here, mapping refers to a process or result of associating elements of one set with elements of another set. Specifically, mapping may be a process of determining whether a target API event is linked to a threat behavior.

The database 20 may store each API event information classified by type as MITRE ATT&CK's Tactics, Techniques, and Procedures (TTPs), and the main server 50 may map a target API event to a corresponding threat behavior based on a classification system stored in the database 20.

For example, API event information containing “login failure” may be mapped to an attack type such as “password cracking” or “brute force attack.”

For example, API event information containing “data deletion” may be mapped to an attack type such as “data destruction” or “insertion/modification.”

In operation S130, the main server 50 determines at least one threat behavior set that includes at least one threat behavior among a plurality of threat behaviors.

Multiple threat behaviors may be determined to be threat behavior set based on a specific threat behavior pattern or scenario. In addition, the threat behavior set may be configured differently depending on the situation. Specifically, if ransomware attacks or DDOS attacks occur frequently during a specific period, a threat behavior set may be configured based on ransomware attack and DDOS attack patterns. Alternatively, when the cloud server 10 performs a system update, a threat behavior set may be configured based on cyber-attacks that frequently occur during the update.

The main server 50 may determine the threat behavior set using the AI engine 40. Specifically, the threat behavior set may be determined based on an AI-based classification algorithm that includes at least one of machine learning, deep learning, or reinforcement learning.

In operation S140, the main server 50 determines, based on the threat behavior set, at least one candidate scenario among a plurality of reference scenarios pre-stored in the database 20.

Here, each reference scenario is a sequence of various tactics, techniques, and procedures (TTPs) included in a threat behavior analysis matrix stored in the MITRE ATT&CK, based on attack patterns used by actual cyber attackers. For example, each reference scenario may be created based on actual security incidents, patterns derived from security research, or experience of security experts.

The main server 50 may determine a reference scenario including the threat behavior set among the plurality of reference scenarios as a candidate scenario. Specifically, the type, sequence, and pattern of threat behaviors included in each reference scenario and threat behavior set may be considered.

In addition, in operation S140, the main server 50 may determine a candidate scenario further based on a cyber-attack stage type.

Here, the cyber-attack stage type refers to a series of steps that an attacker follows to reach his or her objective in a cyber-attack. Based on the Cyber Kill Chain model which is a conceptual model of cyber-attack stages, the cyber-attack stage types may include a pre-attack stage, an attack stage, and a post-attack stage. A sequence of cyber-attack stage types is determined based on temporal occurrence order or causality, and a threat behavior may correspond to at least one cyber-attack stage type.

Specifically, the pre-attack stage is an early stage where a cyber-attack has not yet begun or is in the preparatory phase. The pre-attack stage may include threat behaviors such as collecting information, analyzing targets, and developing attack tools. The attack stage refers to a stage where a cyber-attack is already in progress or the system has been infiltrated. The attack stage may include threat behaviors such as delivering attack tools to a target, exploiting vulnerabilities in the system to execute attack tools, or installing malicious code. The post-attack stage is a stage where an attacker, having already infiltrated the system, undertakes actions to achieve his or her objective. The post-attack stage may include threat behaviors such as the attacker's controlling malicious code, executing additional commands, or erasing traces of stolen information.

In operation S150, the main server 50 produces security indicator information by comparing the candidate scenario with the threat behavior set.

Here, the security indicator information include a plurality of security indicators and may include consistency information and risk information. In addition, the security indicator information may be represented with numerical values. In this case, there are no specific constraints on the numerical range.

Here, the consistency information refers to the consistency between the plurality of reference scenarios pre-stored in the database 20 and the threat behavior set. For instance, the consistency information may be produced based on type relevance of threat behaviors included in the candidate scenario. An indicator corresponding to the type relevance may be produced differentially based on consistency between tactics, techniques, and detailed techniques for sub-classification types of threat behaviors included in the candidate scenario.

For example, if the “B Threat Behavior” identified in the “A Candidate Scenario” utilizes the “Phishing” technique, this technique falls under the “Initial Access” tactic and may include a detailed technique such as “Spearphishing Link” and “Spearphishing Attachment.” If a threat behavior identified in the “A Candidate Scenario” utilize “Spearphishing Link” or “Spearphishing Attachment” as a detailed technique, the actual type relevance between the “Phishing” technique and the “B Threat Behavior” may be calculated to be high.

Here, the risk information may be calculated based on the risk associated with threat behaviors, i.e., techniques, included in each reference scenario pre-stored in the database 20 and in threat behavior set.

Each of the plurality of reference scenarios may include a risk indicator corresponding thereto, and the risk information may be produced based on progress information generated by comparing the risk indicator and a threat behavior included in the threat behavior set and candidate scenario.

For example, in a case where the threat behavior set corresponds to a “Ransomware Attack” among candidate scenarios and a currently detected threat behavior is “Ransomware Attack”, if the progress information indicates an early stage, the risk information may be calculated to be relatively low.

In operation S160, the main server 50 determines an expected threat scenario among the candidate scenarios based on the security indicator information.

Based on the security indicator information, the main server 50 determines a candidate scenario that is most likely, actually occurring, or most likely to occur among the candidate scenarios as an expected threat scenario.

For example, in a case where there are candidate scenarios A and B, both of which have high consistency information when compared to the threat behavior set, the main server 50 may compare risk information of the two scenarios and determine candidate scenario A with higher risk information as an expected threat scenario.

In operation S170, the main server 50 provides solution information to a user terminal based on the expected threat scenario.

Here, the solution information may be a countermeasure plan for the determined expected threat scenario. Specifically, the solution information may include severity, type, attack vector, and other details of the expected threat scenario. In addition, the solution information may be customized on an individual basis, taking into account a user-specific situation.

For example, if the expected threat scenario corresponds to “Social Engineering Attack,” the solution information may include countermeasures such as user education, awareness campaigns, and enhanced email security.

For example, if the expected threat scenario corresponds to “DDOS,” the solution information may include countermeasures such as traffic monitoring and restriction, implementing DDOS defense solutions, and strengthening backup and recovery strategies.

In addition, the solution information may be determined based on a cyber-attack stage type corresponding to the last threat behavior occurring in the expected threat scenario.

Specifically, if the cyber-attack stage type corresponds to the pre-attack stage, a user may be provided with a warning and defensive measures against an initial infiltration attempt. If the cyber-attack stage type corresponds to the attack stage, the user may be provided with detailed information about an attack currently in progress and countermeasures against the attack. If the cyber-attack stage type corresponds to the post-attack stage, the user may be provided with potential threats, preventive measures, and a recovery plan after the attack.

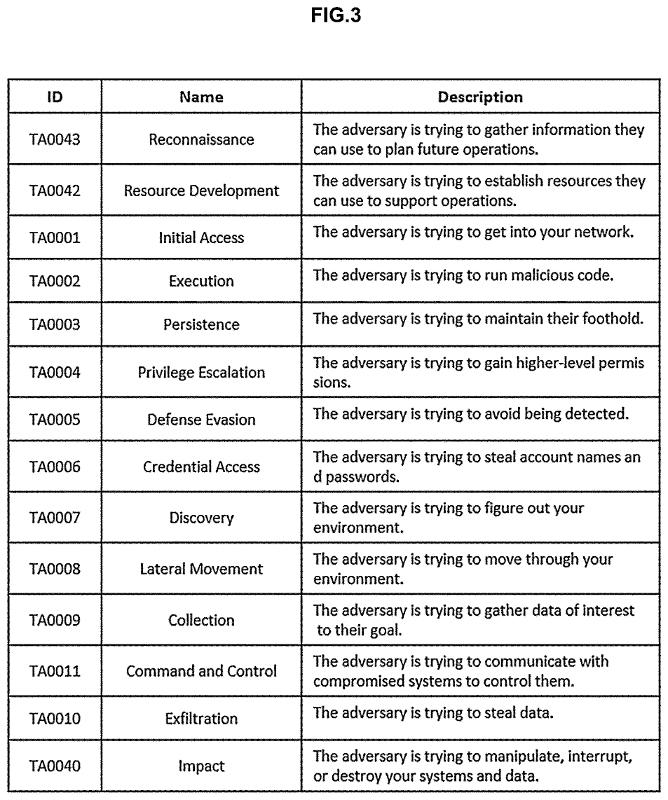

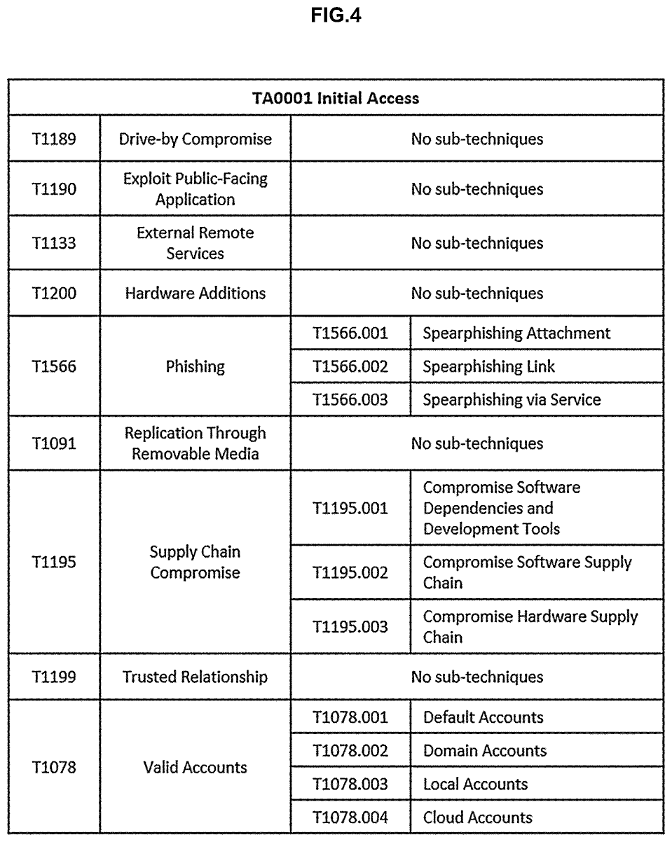

FIGS. 3 and 4 are tables for explaining threat behaviors classified by type according to an embodiment of the present disclosure.

Referring to FIG. 3, there is illustrated information on IDs, names, and descriptions of 14 tactics. Each tactic may include at least one technique.

Referring to FIG. 4, techniques and detailed techniques corresponding to “TA0001 Initial Access” among the tactics in FIG. 3 are shown. Technique “T1566 Phishing” may include “T1566.001”, “T1566.002”, and “T1566.003” as detailed techniques. In addition, there may be techniques that do not include detailed techniques, such as the technique “T1200 Hardware Additions”.

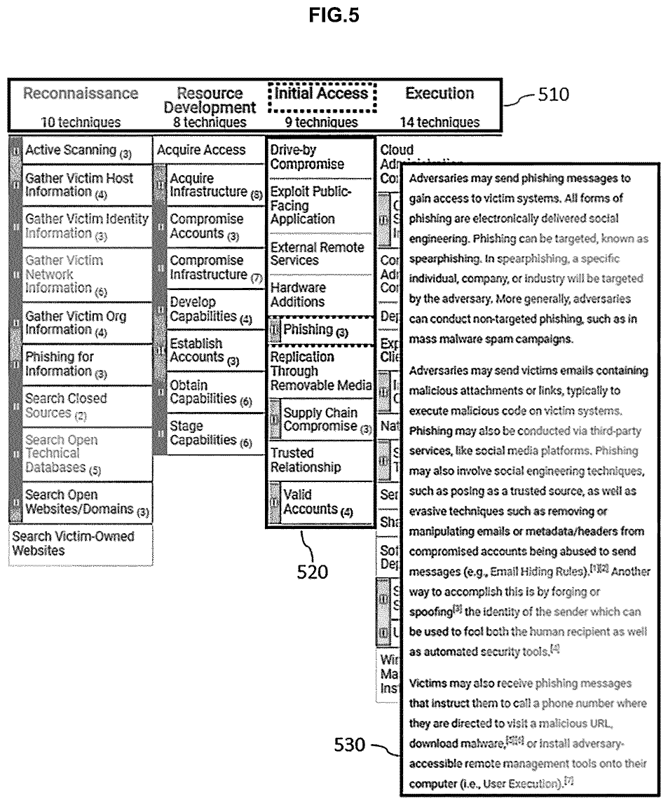

FIG. 5 is a diagram illustrating an example of a threat behavior analysis matrix according to an embodiment of the present disclosure.

FIG. 5 will be described with reference to FIGS. 3 and 4.

Referring to FIG. 5, four tactics 510, and techniques 520 and procedures 530 of TA001 are shown.

Referring to FIG. 5, the techniques corresponding to the four tactics 510 are shown. The techniques corresponding to “TA0001 Initial Access” among the tactics in FIG. 3 are listed as the techniques 520 of TA001. If “Phishing” corresponding to the technique “T1566 Phishing” in FIG. 4 among the techniques 520 of TA001 is selected, it is possible to check a procedure 530 corresponding thereto.

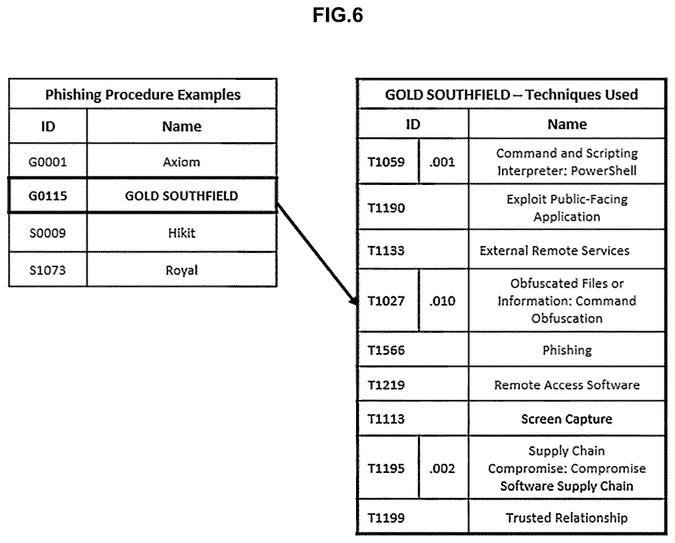

FIG. 6 is a table explaining a plurality of pre-stored reference scenarios according to an embodiment of the present disclosure.

FIG. 6 will be described with reference to FIGS. 2 and 5.

Referring to FIG. 6, “Axiom”, “GOLD SOUTHFIELD”, “Hikit”, and “Royal”, which are cyber-attack scenarios corresponding to “Phishing” in FIG. 5, are shown. Also, technique and detailed techniques for “GOLD SOUTHFIELD” are shown.

Referring to FIG. 6, the illustrated cyber-attack scenarios “Axiom”, “GOLD SOUTHFIELD”, “Hikit”, and “Royal” may be part of the plurality of pre-stored reference scenarios which is mentioned in operation S140.

For example, if “A1 threat behavior set” among threat behavior sets determined in operation S130 includes “T1190”, “T1133”, and “T1195.002” as techniques and detailed techniques, “GOLD SOUTHFIELD” may be determined as a candidate scenario based on “A1 threat behavior set” in operation S140. If the candidate scenario “GOLD SOUTHFIELD” is determined as an expected threat scenario in operation S160, the solution information provided in operation S170 for the techniques included in the “A1 Threat Behavior Set,” which is part of the expected threat scenario “GOLD SOUTHFIELD,” may suggest a method to block the ongoing attack and isolate the system. For techniques not included in the “A1 threat behavior set”, notifying the possibility of an attack or strengthening system security may be suggested.

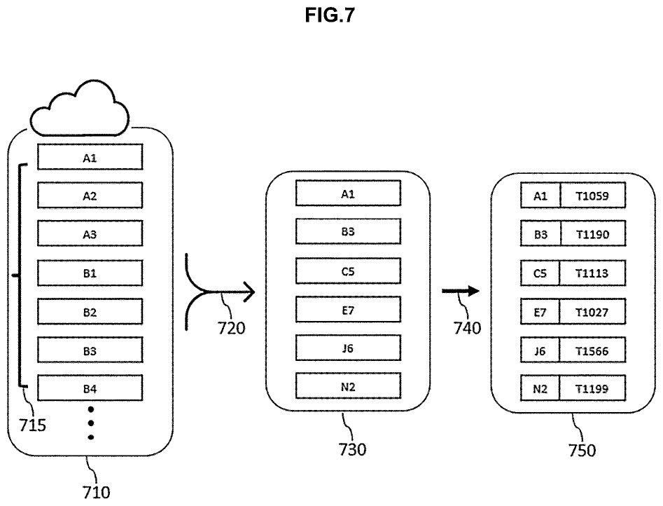

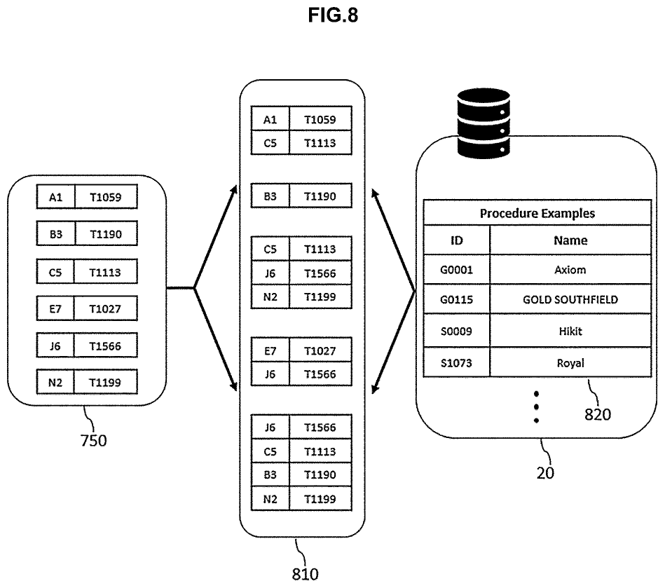

FIGS. 7 and 8 are diagrams illustrating a method for determining a threat scenario according to an embodiment of the present disclosure.

FIGS. 7 and 8 exemplarily show the process that unfolds as the main server 50 performs the operations shown in FIG. 2. Therefore, FIGS. 7 and 8 will be described with reference to FIG. 2.

Referring to FIG. 7, in operation S110, the main server 50 acquires API event information 715 from a cloud environment 710, and acquires a plurality of target API events 730 based on predetermined criteria 720 among the acquired API event information 715. In operation S120, the main server 50 maps the plurality of target API events 730 to threat behaviors classified by type in 740.

Referring to FIG. 8, a threat behavior set 810 including at least one threat behavior among the plurality of target API events 750 mapped in operation S130 is determined. In operation S140, at least one candidate scenario among a plurality of reference scenarios 820 pre-stored in the database 20 is determined based on the threat behavior set 810.

The database 20 may store relationship information about time intervals and causal relationships between threat behaviors included in each reference scenario, and a threat behavior set may be determined based on the relationship information in operation S130.

For example, suppose that there is an attack scenario in which a cyber attacker gains initial access through a “Phishing” attack and then performs a series of actions within the system to obtain additional authority. In this case, by analyzing time intervals and causal relationships between the initial access event using “Phishing” and the event for obtaining the additional authority, it is possible to determine a threat behavior set among a plurality of threat behaviors based on similar time intervals and causal relationships between the events.

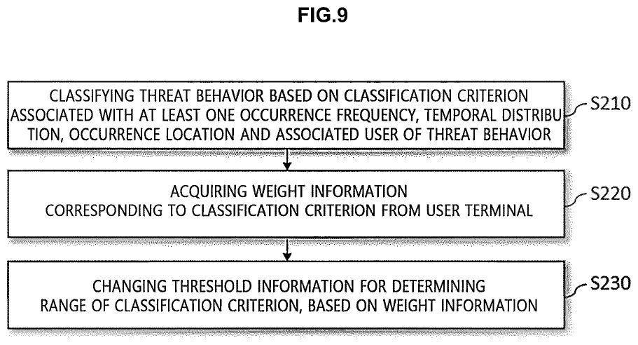

FIG. 9 is a flowchart illustrating a method for determining a threat scenario according to another embodiment of the present disclosure.

In operation S210, the main server 50 classifies a threat behavior based on a classification criterion associated with at least one of a frequency of occurrence, temporal distribution, occurrence location, and associated user of the threat behavior.

For example, if a threat behavior predominantly originates from a specific user or is concentrated at a specific time, the threat behavior may be classified as either a threat behavior originating from the specific user or a threat behavior occurring at the specific time, based on the classification criterion. In addition, the threat behavior set may be determined among threat behaviors grouped in the same category.

In operation S220, the main server 50 acquire weight information corresponding to the classification criterion from the user terminal.

For example, if a higher weight is assigned to the “occurrence location” from the user terminal, a threat behavior occurring at that location may be necessarily included in the threat behavior set.

In operation S230, the main server 50 changes threshold information for determining a range of the classification criterion, based on the weight information.

For example, by changing the threshold of “occurrence frequency”, only threat behaviors with a frequency above a predetermined threshold may be classified into a threat behavior set.

In the method for determining a threat scenario using generative AI according to the present disclosure, it is possible to effectively defend against scenario-based cyber-attacks through scenario-based multi-stage attack analysis based on the generative AI and to provide solutions so as to preemptively respond to the attacks.

The technical features disclosed in each embodiment of the present disclosure are not limited only to a corresponding embodiment, but the technical features in the respective embodiments may be combined and applied to different embodiments unless they are mutually incompatible.

Therefore, although each embodiment has been described mainly about a technical feature thereof, the technical features may be combined unless they are mutually incompatible.

The present disclosure is not limited to the above-described embodiment and the accompanying drawings, and various modifications and changes may be made in view of the person skilled in the art to which the present disclosure pertains. Therefore, the scope of the present disclosure should be defined by the equivalents of claims of the present disclosure as well as the claims.

What is claimed is:

1. A method for determining a threat scenario, the method comprising the steps of:
determining a plurality of target API events based on predetermined criteria among a user's API event information obtained in a cloud environment, wherein the predetermined criteria is associated with at least one of occurrence frequency, temporal distribution, occurrence location, associated user, and type of an API event;
mapping the plurality of target API events respectively to a plurality of threat behaviors classified by type;
determining at least one threat behavior set including at least one threat behavior among the plurality of threat behaviors;
based on the threat behavior set, determining at least one candidate scenario among a plurality of reference scenarios pre-stored in a database;
producing security indicator information by comparing the at least one candidate scenario with the threat behavior set;
determining an expected threat scenario among the at least one candidate scenario based on the security indicator information; and
providing a user terminal with solution information based on the expected threat scenario.

2. The method of claim 1, wherein sub-classification types of the threat behaviors comprise tactics, techniques, and detailed techniques, wherein each of the tactics is a higher-level concept comprising at least one of the techniques and each of the techniques is a higher-level concept comprising at least one of the detailed techniques.

3. The method of claim 1, wherein the security indicator information comprises consistency information and risk information.

4. The method of claim 3, wherein the consistency information is produced based on type relevance to threat behaviors included in the at least one candidate scenario.

5. The method of claim 4, wherein:
sub-classification types of the threat behaviors comprise tactics, techniques, and detailed techniques, wherein each of the tactics is a higher-level concept comprising at least one of the techniques and each of the techniques is a higher-level concept comprising at least one of the detailed techniques, and
an indicator corresponding to the type relevance is produced differentially based on consistency between the tactics, the techniques, and the detailed techniques for the threat behaviors included in the at least one candidate scenario.

6. The method of claim 1, wherein:
the security indicator information comprises risk information,
each of the plurality of reference scenarios pre-stored in the database comprises a risk indicator corresponding thereto, and
the risk information is produced based on progress information that is generated by comparing the risk indicator and a threat behavior included in the threat behavior set and the at least one candidate scenario.

7. The method of claim 1, wherein the plurality of reference scenarios pre-stored in the database are scenarios each composed of at least some threat behaviors selected from a plurality of techniques included in a threat behavior analysis matrix, wherein the threat behavior analysis matrix is composed of a plurality of tactics and at least one technique included in each of the plurality of tactics.

8. The method of claim 1, wherein:
in the determining of the at least one candidate scenario, the at least one candidate scenario is determined further based on cyber-attack stage types,
the cyber-attack stage types comprise a pre-attack stage, an attack stage, and a post-attack stage based on Cyber Kill Chain model, and a sequence of the stages is determined by temporal occurrence order or causality,
the threat behavior corresponds to at least one of the cyber-attack stage types.

9. The method of claim 8, wherein the solution information is determined based on a cyber-attack stage type corresponding to a last threat behavior occurring in the expected threat scenario.

10. The method of claim 9, wherein:
when the cyber-attack stage type corresponds to the pre-attack stage, the user is provided with a warning and defensive measures against an initial infiltration attempt,
when the cyber-attack stage type corresponds to the attack stage, the user is provided with detailed information regarding an attack currently in progress and countermeasures therefor, and
when the cyber-attack stage type corresponds to the post-attack stage, the user is provided with potential threats, preventive measures, and a recovery plan after the attack.

11. The method of claim 9, wherein at least one of the predetermined criteria is determined based on the cyber-attack stage type.

12. The method of claim 1, wherein:
the determining of the threat behavior set further comprises: classifying the threat behavior based on a classification criterion associated with to at least one of occurrence frequency, temporal distribution, occurrence location, and associated user of the threat behavior, and
the threat behavior set is composed of threat behaviors determined based on the classification criterion.

13. The method of claim 12, further comprising:
acquiring weight information corresponding to a classification criterion from the user terminal; and
changing threshold information for determining a range of the classification criterion, based on the weight information.

14. The method of claim 1, wherein:
the threat behavior set is determined based on an AI-based classification algorithm, and
the classification algorithm comprises at least one of machine learning, deep learning, or reinforcement learning.

15. The method of claim 1, wherein:
the database stores relationship information regarding time intervals and causal relationships between threat behaviors included in each of the plurality of reference scenarios,
in the determining of the threat behavior set, the threat behavior set is determined based on the relationship information.
